(19) United States
(12) Patent Application Publication
(10) Pub. No.: US 2015/0339380 A1
(43) Pub. Date: Nov. 26, 2015

(54) METHOD AND APPARATUS FOR VIDEO RETRIEVAL

(71) Applicant: THOMSON LICENSING, Issy-Les- Moulineaux (FR)

(72) Inventors: Yanfeng ZHANG, Beijing (CN); Zhigang ZHANG, Beijing (CN); Jun XU, Beijing (CN)

(21) Appl. No.: 14/648,701

(22) PCT Filed: Nov. 30, 2012
(86) PCT No.: PCT/CN2012/085637

§ 371 Date: May 30, 2015

(51) Int. Cl. G06F 17/30; G06F 3/0482

(52) U.S. Cl. CPC G06F 17/30799; G06F 17/3053; G06F 17/3084; G06F 3/0482

(57) ABSTRACT

The invention provides a method and apparatus for video retrieval. The method comprises: providing a user interface for a user to input a text query relevant to a video to be retrieved; carrying out a text-based image searching based on the text query to provide a plurality of images relevant to the video; and carrying out an example-based video retrieval based on one image selected by the user from the plurality of images.

### TECHNICAL FIELD

The present invention relates to a method and apparatus for video retrieval.

### BACKGROUND

Conventional video retrieval systems, such as Google video searching, Youtube, etc., solely rely on textual queries inputted by users. Based on a searching text (e.g. keyword) inputted by a user, a conventional video retrieval system will search relevant video materials by executing text matching on title, annotation or text surrounding. Such text-based method has two disadvantages. One is that users are often reluctant to input such text information, especially to input detail description for the whole video document. The other disadvantage is that the quality of inputted annotations, most of which just gives very brief description of the video document, is normally not good.

Many research activities have been done on low-level content-based video retrieval, such as Informedia Digital Video Library project of Carnegie Mellon University (http://www.informedia.cs.cmu.edu/). This project tries to achieve machine understanding of video and film media, including all aspects of search, retrieval, visualization and summarization. The base technology developed combines speech, image and natural language understanding to automatically transcribe, segment and index linear video for intelligent search and image retrieval.

Example-based searching methods have been widely investigated for describing searching intention of users in low-level content-based multimedia retrieval. For example, with an image example or a clip of melody, the similar pictures or the whole music containing the melody can be retrieved from corresponding multimedia database. However, in low-level content-based video retrieval, it is difficult for users to describe and present their video searching intention. The most convenient way for people to is to use words or sentences to present it. Further, in many real world applications, it is hard to find an example to describe the user's information needs. Therefore, for low-level content based video retrieval, there exists a big semantic gap between users' intention description and the capacity of retrieval system to understand. Users mostly prefer to input their text-style query requirement, while the content-based video retrieval methods are mainly based on inputted example query. It is difficult for users to make or find a suitable query example for video retrieval.

To bridge the semantic gap between low-level features and the searching intention of a user, research activities have been done to annotate multimedia using text either by annotation inputting manually or by content recognition automatically. Manual annotation presents the same shortages with the text-based retrieval. Machine automatic annotation is too difficult, which seems unlikely to be solved in a near term. Abstract keywords are almost impossible to correlate to image content.

### SUMMARY

According one aspect of the invention, a method for video retrieval is provided. The method comprises: providing a user interface for a user to input a text query relevant to a video to be retrieved; carrying out a text-based image searching based on the text query to provide a plurality of images relevant to the video; and carrying out an example-based video retrieval based on one image selected by the user from the plurality of images.

According one aspect of the invention, an apparatus for video retrieval is provided. The apparatus comprises: means for providing a user interface for a user to input a text query relevant to a video to be retrieved; means for carrying out a text-based image searching in an image database based on the text query inputted by the user to provide a plurality of images relevant to the video; and means for carrying out an example-based video retrieval in a video database based on one image selected by the user from the plurality of images.

It is to be understood that more aspects and advantages of the invention will be found in the following detailed description of the present invention.

### BRIEF DESCRIPTION OF THE DRAWINGS

The accompanying drawings are included to provide further understanding of the embodiments of the invention together with the description which serves to explain the principle of the embodiments. The invention is not limited to the embodiments.

In the drawings:

FIG. 1 is an exemplary diagram showing a system for video retrieval according to an embodiment of the invention;

FIG. 2 is a flow chart of a method for video retrieval according to an embodiment of the invention;

FIG. 3 is an exemplary diagram showing a video query dialog for the user to input a text query;

FIG. 4 is an exemplary diagram showing an example of a photo in Flickr with metadata that could be used for the text-based image searching; and

FIG. 5 is a block diagram of an apparatus for video retrieval according to an embodiment of the invention;

### DETAILED DESCRIPTION

An embodiment of the present invention will now be described in detail in conjunction with the drawings. In the following description, some detailed descriptions of known functions and configurations may be omitted for conciseness.

In view of the above problem in the conventional technologies, an embodiment of the invention provides a method and apparatus for video retrieval.

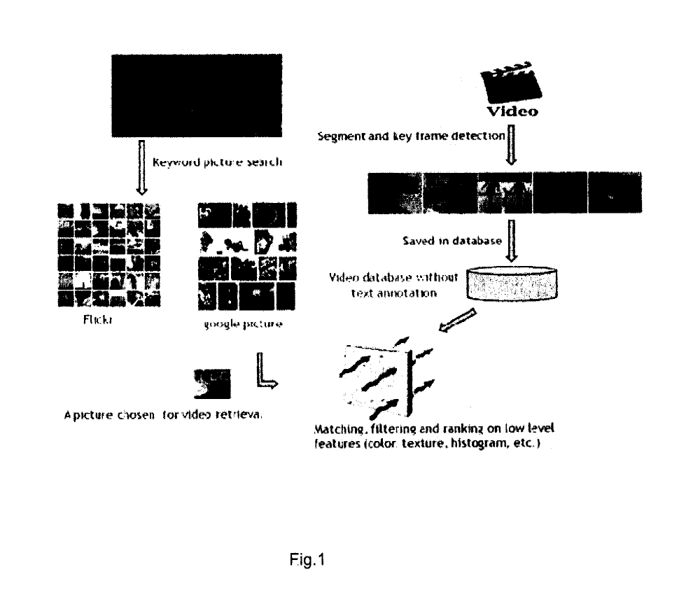

FIG. 1 is an exemplary diagram showing a system for video retrieval according to an embodiment of the invention.

As shown in FIG. 1, the video retrieval system according to an embodiment of the invention proposes to have text-based image searching first to provide a plurality of images relevant to the video, from which one image is selected by the user to carry out an example-based video retrieval to provide an output of the video retrieval.

Next, the embodiment of the present invention will be described in more details.

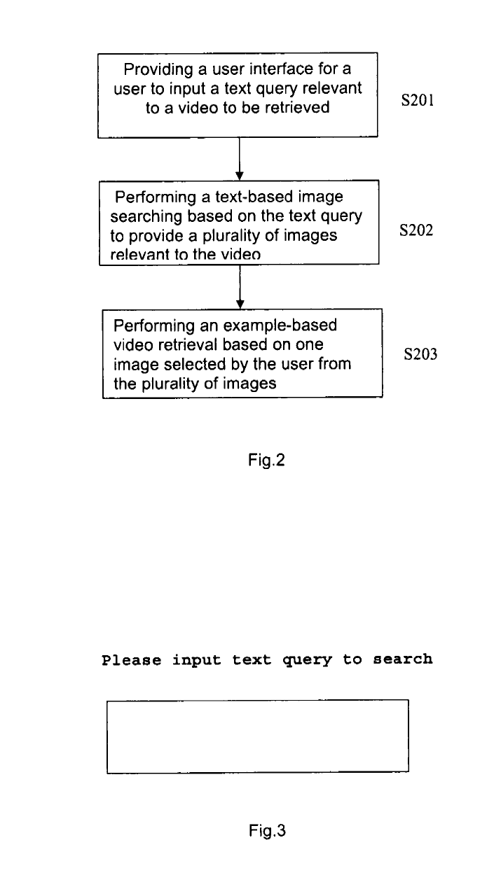

FIG. 2 is a flow chart of a method for video retrieval according to an embodiment of the invention.

As shown in FIG. 2, the method for video retrieval according to an embodiment of the invention comprises the following steps:

S201: providing a user interface for a user to input a text query relevant to a video to be retrieved;

S202: carrying out a text-based image searching based on the text query to provide a plurality of images relevant to the video;

S203: carrying out an example-based video retrieval based on one image selected by the user from the plurality of images.

Next, the method for video retrieval according to an embodiment of the invention will be described in details.

With the above step S101, a user interface could be provided for a user of video retrieval to input a text query relevant to a video to be retrieved. As an example, the user interface could be a video query dialog for the user to input a text query relevant to the video. FIG. 3 is an exemplary diagram showing a video query dialog for the user to input a text query. It could be appreciated that other appropriate forms of user interface can also be applied. The text query is a description of the content of the video in the form of words or sentences. The reason for using the text query is that normally the most convenient way for a user of video retrieval to express his/her intention is to use text description, instead of preparing image examples or sketching a target.

With the step S102, a text-based image searching is carried out based on the text query inputted by the user to provide a plurality of images relevant to the video. The text-based image searching can be executed on external image database, such as image sharing social networks and image searching engines, or on internal image database, such as the user's own image example library. It could be appreciated that, when external image database is used, API (Application Programming Interface) requested by the database should be used. It should be noted that any appropriate technologies in this respect can be used for the text-based image searching.

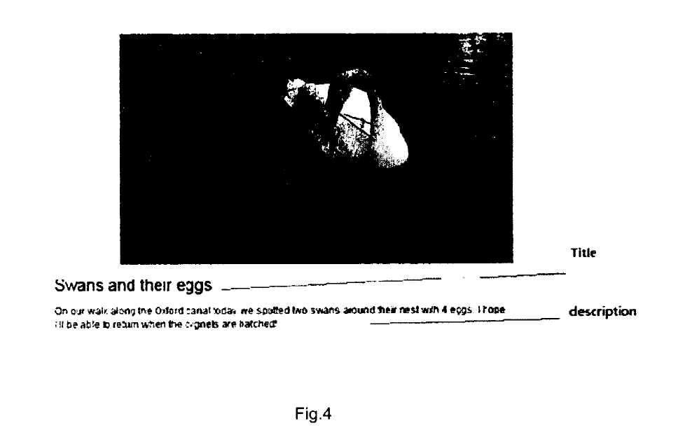

Flickr is one of the image sharing social networks that could be used for the text-based image searching. When Flickr is used in step S102, the text-based image searching can be executed, for example, by the text matching on the image annotation added by photo providers in Flickr. Photos in Flickr contain different types of metadata, ranging from technical details to more subjective information. At a low level, information concerns the camera, shutter speed, rotation, etc. At a higher level, a user that uploaded a photo onto Flickr can add a title and relevant description, which are more likely to be used to describe the image in the photo as a whole. FIG. 4 is an exemplary diagram showing an example of a photo in Flickr with metadata that could be used for the text-based image searching. A photo of swan is shown in FIG. 4, with title and relevant description of the photo, added perhaps by the image provider. A text matching between the text query inputted by the user and the title and relevant description of the photo is carried out to estimate whether the image in the phone is relevant to the video to be retrieved.

Known image searching engines include Google Image Searching, Yahoo Image, Bing Image, etc. When Google Image Searching is used in step S102, the text-based image searching can be executed, for example, by the surrounding text searched by Google image searching. Text in a webpage which contains an image is one example of the above-mentioned surrounding text. Google Image Searching tries to find the images whose surrounding text information has relevancy with the keyword query inputted by a user.

When the text-based image searching is executed on internal image database, text annotation and text tags added by the builder of internal image database can be used. The use of tags permits the builder to describe what he thinks is relevant to the image using simple keyword combinations.

One relevant image can be selected from the searching result of the step S102, which may contain a plurality of images, as an input for the following video retrieval. In this respect, since some image sharing social networks and image search engines can provide ranking mechanism for the text-based image searching results according to the relevancy of the images, it is possible to automatically select the relevant image. However, preferably, the searching result of the step S102 is displayed to the user with an appropriate user interface for the user to browse and select the most relevant image as an input for the following video retrieval. The reason why the embodiment of the invention recommends manual selection by the user is that it is still very difficult for a machine (image sharing social networks and image search engines) to fully understand the query intention and select the most relevant image better than the user.

It could be appreciated that if the user is not satisfied with any images in the result of the step S101, the process can go back to step S101 for the user to revise the text query or input a new text query.

Then with the step S103, an example-based video retrieval is carried out based on the image selected by the user.

Some conventional methods have been developed for the purpose of example-based video retrieval, including for example spoken document retrieval, VOCR (Video Optical Character Recognition) and image similarity matching.

With spoken document retrieval, a textual representation of the audio content from a video can be obtained through automatic speech recognition. But a limitation of the usage of spoken document retrieval is that a clear and recognizable voice in the video materials is required.

With VOCR, a textual representation of video is obtained by reading the text that is presented in the video image. Then retrieval is carried out based on text (keyword). But in order to apply VOCR, there must exist some recognizable text information in the video. That is one limitation for the usage of VOCR.

The image similarity matching is an example-based image retrieval method which has been immigrated into video retrieval field. The image search engine of the image similarity matching can accept a deliberately prepared image example and then use the example to find the similar images from an image database. When the method is used in video retrieval, the image example is used to find the similar key frames which have been extracted from a video. So far there was no large-scale and standardized method on how to evaluate the similarity of two images. Most of the used methods in this respect are based on features such as color, texture and shape that are extracted from the image pixels.

It could be appreciated that the above methods can be combined to form more complex method for video retrieval.

In the embodiment of the invention, since the input to the video retrieval contains images selected by the user from the searching result of the step S102, it is preferably to apply the image similarity matching method for the example-based video retrieval.

Next, a detailed description will be given to the example-based video retrieval with the image similarity matching method.

It is known that a video, before stored into a database, will be subjected to a video structure parsing including segment and key frame detection. The segment is used to cut the video into individual scenes. Each scene consists of a series of consecutive frames and those frames which are filmed in the same location or share thematic content will be grouped together. The Key frame detection is to find a typical image from an individual scene as the indexing image. Conventional video segment and key frame extraction algorithms could be used in this respect. For example, shot boundary detection algorithm is such a solution which can segment the video into frames with similar visual contents depending on visual information contained in the video frames. After extraction of the key frame, metadata is added to each key frame. The metadata presents which video the key frame has been extracted and the concrete position of the key frame in a specific video.

Then the degree of similarity between the features of the search query (the image selected by the user) and those of key frames of a video stored in the database can be computed by using a matching algorithm, which decides the rank of relevancy of retrieved video. There are conventional image matching algorithms known in the art. Traditional methods for content-based image retrieval are based on a vector model. In these methods, an image is represented by a set of features and the difference between two images is measured through a distance, usually a Euclidean distance, between their feature vectors. The distance decides the similarity degree of the two images, and also decides the rank of the corresponding video. Most image retrieval systems are based on features such as color, texture, and shape that are extracted from image pixels.

After the similar key frames are found and ranked, the metadata added in video structure parsing phase, can be used to decide which videos should be retrieved, the right first frame of each video, and the ranks of the relevancy between each video with the query of the user. Then, a list of retrieved video documents, which can be arranged according a corresponding ranking, is presented to the user.

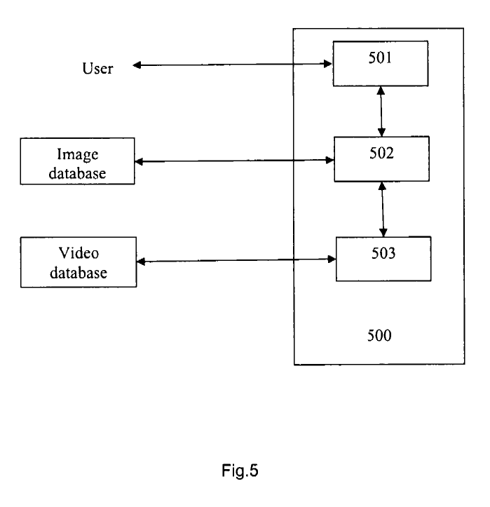

FIG. 5 is a block diagram of an apparatus for video retrieval according to an embodiment of the invention.

As shown in FIG. 5, the apparatus for video retrieval 500 comprises a user interface providing unit 501 for providing a user interface for a user to input a text query relevant to a video to be retrieved; an image searching unit 502 for carrying out a text-based image searching in an image database based on the text query inputted by the user to provide a plurality of images relevant to the video; and a video retrieval unit 503 for carrying out an example-based video retrieval in a video database based on one image selected by the user from the plurality of images.

As an example, the user interface providing unit 501 can provide a video query dialog for the user to input a text query relevant to the video.

As described in the method for video retrieval, the image database could be an internal image database, such as an image example library of the user. The image database could also be an external image database, such as image sharing social networks and image searching engines. In this case the image searching unit 502 is provided with corresponding API (Application Programming Interface) requested by the external image database.

The video retrieval unit 503 carries out the example-based video retrieval with an image similarity matching algorithm. In this case, key frames of a video in the video database need to be provided with metadata that presents which video the key frame has been extracted and the concrete position of the key frame in a specific video. The metadata can be obtained by a video structure parsing made to the video data before stored into the database.

The apparatus for video retrieval 500 can also comprise a displaying unit to display the example-based video retrieval result to the user in an appropriate form. The result of the video retrieval can be displayed to the user according to the ranking of relevancy of a video in the result.

It is to be understood that the present invention may be implemented in various forms of hardware, software, firmware, special purpose processors, or a combination thereof.

1. A method for video retrieval, comprising:
providing a user interface for a user to input a text query relevant to a video to be retrieved;
carrying out a text-based image searching based on the text query to provide a plurality of images relevant to the video;
carrying out an example-based video retrieval based on one image selected by the user from the plurality of images.

2. The method according to claim 1, wherein the user interface is a video query dialog.

3. The method according to claim 1, wherein the text-based image searching is executed by a text matching between the text query and metadata of an image.

4. The method according to claim 3, wherein the metadata comprises text annotation, surrounding text and text tag of the image.

5. The method according to claim 1, wherein the example-based video retrieval is executed by image similarity matching between a feature of the image selected by the user and that of a key frame of a video.

6. The method according to claim 5, wherein the feature comprises a color, a texture and a shape which are extracted from the image pixels of the key frame.

7. The method according to claim 1, further comprising:
presenting the result of the example-based video retrieval to the user according to the ranking of relevancy of a video in the result.

8. An apparatus for video retrieval, comprising:
means for providing a user interface for a user to input a text query relevant to a video to be retrieved;
means for carrying out a text-based image searching in an image database based on the text query inputted by the user to provide a plurality of images relevant to the video; and
means for carrying out an example-based video retrieval in a video database based on one image selected by the user from the plurality of images.

9. The apparatus according to claim 8, wherein the user interface is a video query dialog.

10. The apparatus according to claim 8, wherein the image database is an external database and means for carrying out a text-based image searching comprises an Application Programming Interface with the image database.

11. The apparatus according to claim 8, wherein means for carrying out an example-based video retrieval carries an image similarity matching between a feature of the image selected by the user and that of a key frame of a video in the video database.

12. The apparatus according to claim 11, wherein the example-based video retrieval is executed by image similarity matching between a feature of the image selected by the user and that of a key frame of a video.

13. The according to claim 12, wherein the feature comprises a color, a texture and a shape which are extracted from the image pixels of the key frame.

14. The apparatus according to claim 8, further comprising means for displaying the result of the example-based video retrieval to the user.
